(19) United States
(12) Patent Application Publication
(10) Pub. No.: US 2024/0145928 A1
(43) Pub. Date: May 2, 2024

(54) ON-PACKAGE SIGNAL LAUNCH AND ANTENNA STRUCTURE

(71) Applicant: Texas Instruments Incorporated, Dallas, TX (US)

(72) Inventors: Zachary Crawford, Dallas, TX (US); Mohammad Vatankhah Varnoosfaderani, Dallas, TX (US); Hassan Ali, Murphy, TX (US); Claudia Vasanelli, Munich (DE); Swaminathan Sankaran, Allen, TX (US)

(21) Appl. No.: 18/194,438

(22) Filed: Mar. 31, 2023

Related U.S. Application Data
(60) Provisional application No. 63/420,167, filed on Oct. 28, 2022.

(51) Int. Cl. H01Q 13/10; H01Q 1/22; H01Q 13/06

(52) U.S. Cl. CPC H01Q 13/106; H01Q 1/2283; H01Q 13/06

(57) ABSTRACT

A device with a circuit board including a top surface and a bottom surface, a package including a bottom surface affixed relative to the top surface of the circuit board, and an antenna structure affixed relative to the bottom surface of the circuit board. The antenna structure extends through an opening in the circuit board.

### CROSS-REFERENCE TO RELATED APPLICATION

This application claims the benefit of and priority to U.S. Provisional Application No. 63/420,167, filed Oct. 28, 2022, which is incorporated herein by reference.

### BACKGROUND

High frequency integrated circuits (ICs) generate millimeter wave signals such as those used for automotive radar, from approximately 76 GHz to 81 GHz. In conventional IC packaging, these signals are transitioned to planar transmission lines on a circuit board, for example through a ball grid array. Planar transmission lines carry the signal from one location on the circuit board to another, such as from a signal ball pad to an external waveguide launch. The external waveguide can be used to feed a three-dimensional antenna.

Examples are described that may improve on the above considerations.

### SUMMARY

In one example, there is a device, comprising a circuit board including a top surface and a bottom surface, a package including a bottom surface affixed relative to the top surface of the circuit board, and an antenna structure affixed relative to the bottom surface of the circuit board. The antenna structure extends through an opening in the circuit board.

Other aspects are also described and claimed.

### BRIEF DESCRIPTION OF THE DRAWINGS

FIG. 1 is a diagram of a circuit board 100.

FIG. 2 shows a cross-sectional side view of a circuit board 200.

FIG. 3 is perspective diagram a package 310.

FIG. 4 is a diagram of a circuit board 400.

FIG. 5 is a cross-sectional side-view diagram of package 502.

FIGS. 6A and 6B are respective plan and perspective diagrams of a signal launch in the form of a slot antenna 602.

FIGS. 6C and 6D illustrate additional partial, perspective views of selected items of the FIGS. 6A and 6B slot antenna 602.

FIG. 7 is a diagram of a single-ridge aperture for a slot antenna 700.

FIG. 8A is a cross-sectional side-view, and FIG. 8B is a perspective and exploded view, of an antenna structure 802.

FIG. 8C illustrates a plan view of portions of the interfacing area between the FIGS. 8A and 8B structure.

### DETAILED DESCRIPTION

Specific examples are described below in detail with reference to the accompanying figures. It is understood that these examples are not intended to be limiting, and unless otherwise noted, no feature is required for any particular example. Moreover, the formation of a first feature over or on a second feature in the description that follows may include examples in which the first and second features are formed in direct contact and examples in which additional features are formed between the first and second features, such that the first and second features are not in direct contact.

Routing high frequency signals through planar transmission lines increases the complexity and cost of manufacturing a circuit board and often results in signal power loss. Some integrated circuits (ICs) use a direct interface between the packaged IC device and external waveguides, rather than planar transmission lines. Direct interfaces should have low coupling losses and high isolation between signal channels. Moreover, direct interfaces should also be robust to manufacturing and assembly tolerances.

A device of this disclosure may include a direct interface between an antenna structure and one or more slot antennas on an IC package. To achieve this direct interface, a cutout portion of the circuit board may be removed, or otherwise provided for, to allow for an extension of the antenna structure to protrude through the cutout in the circuit board and toward the one or more slot antennas on the IC package. Accordingly, when the IC package is mounted on a circuit board, a slot antenna on the package may be in direct contact, or very close proximity, with the antenna structure extension that protrudes through the circuit board cutout.

This design may allow for any one or more of smaller antennas, smaller circuit board cutouts, and fewer ball grid array (BGA) balls in the system. In some examples, the system may be any one or more of less complex, easier to fabricate, and easier to assemble because of this design. Moreover, the system may have improved frequency characteristics and lower signal losses than other designs. Of course, these advantages are merely examples, and no advantage is required for any particular example.

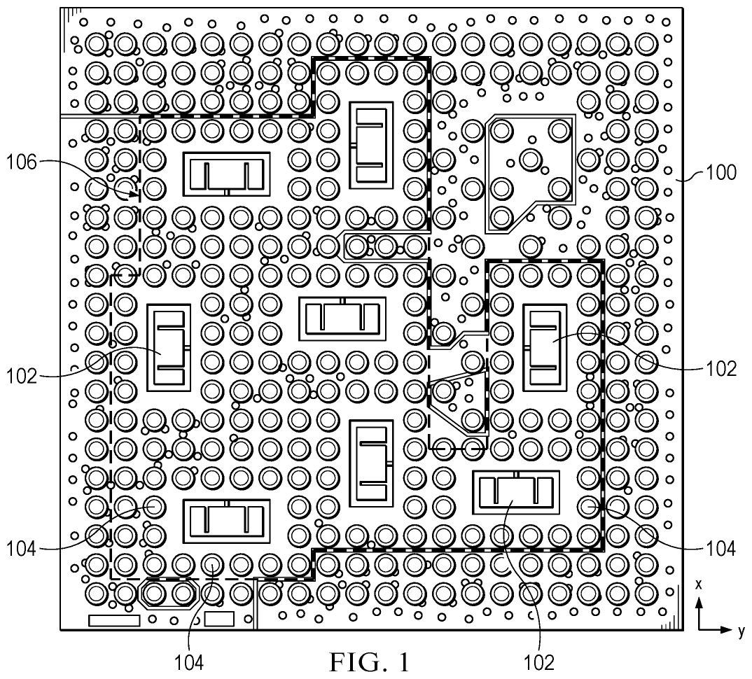

Examples of launch coupling mechanisms are described with reference to the figures below. In that regard, FIG. 1 is a diagram of a circuit board 100, such as a printed circuit board (PCB). The circuit board 100 includes a plural number (e.g., eight) of waveguide launches 102 positioned among a BGA formed by BGA balls 104. In FIG. 1 and later figures, x-y (or x-y-z) coordinate directions are also illustrated, where in FIG. 1 the circuit board 100 is generally along the x-y plane (and may have a thickness in the z-dimension, understood to be extending a direction into the image). The directional references are for purposes of relative placement, but such terms are not intended to be restrictive as the device may be rotated in space and thereby change absolute, but not relative, references.

Additional example details of waveguide launches and BGAs can be found in commonly assigned U.S. Pat. No. 11,196,146, entitled “Grounded BGA Wave-Guiding Interface Between an On-Package Signal Launch and an External Waveguide,” issued on Dec. 7, 2021, and U.S. patent application Ser. No. 18/091,295, entitled “Wireless System Package,” filed Dec. 29, 2022, each of which is incorporated by reference in its entirety.

Most of the area on the circuit board 100 is occupied by the waveguide launches 102 and the surrounding BGA balls 104, as indicated by a dashed black perimeter outline 106. Each waveguide launch 102 on the circuit board 100 occupies the area of two-by-four balls 104, for a total area of eight balls. A rectangular perimeter of sixteen balls 104 surround each waveguide launch 102, with the sixteen balls 104 arranged in a four-by-six rectangle with the inner twelve of those balls not provided, as the area is occupied by the ball-surrounded launch 102. Each of these sixteen balls 104, and all of the balls within the dashed black perimeter outline 106, may be grounded to provide isolation for the signals transmitted or received by the respective waveguide launch 102. The balls 104 outside of the dashed black perimeter outline 106 may be grounded, coupled to a power supply, coupled to an analog-to-digital converter in the package, or used for signal transmission (e.g., general purpose or specific purpose input/output).

It may be desirable to reduce the area occupied by each waveguide launch 102 and the surrounding balls 104 on the circuit board 100. Each of the waveguide launches 102 and surrounding balls 104 on the circuit board 100 occupy a four-by-six area, for an equivalent space corresponding to a total of twenty-four balls. This disclosure describes techniques that can be used to reduce the area for each waveguide launch 102 and the surrounding balls 104 may be reduced, for examples to four-by five (twenty balls), three-by-six (eighteen balls), or three-by-five balls (fifteen balls).

Reducing this area may allow for any one or more of a smaller size for the circuit board 100, an increased number of waveguide launches on the circuit board 100, and/or adding other functionality to the circuit board 100. For example, smaller waveguides having a smaller BGA footprint may free up space on the circuit board 100 for other functionality. Although the techniques described herein are described in terms of reducing area on the circuit board 100, the techniques of this disclosure also may be used with larger-area waveguide launches, such as the four-by-six arrangement shown in FIG. 1.

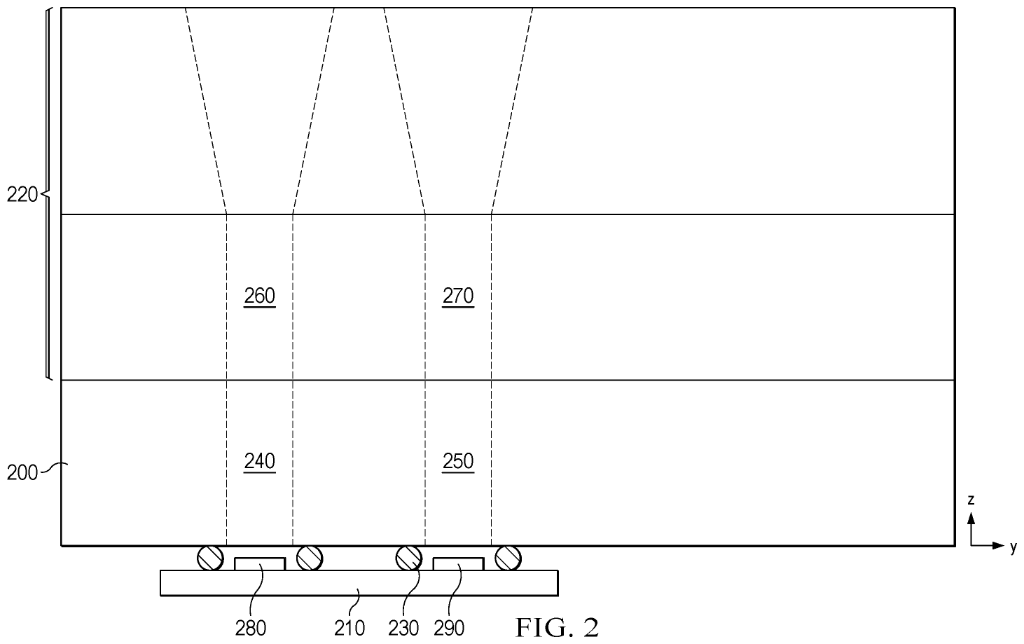

FIG. 2 shows a cross-sectional side view of a circuit board 200, IC package 210, and antenna structure 220. The IC package 210 is attached to the circuit board 200 via a BGA, which includes the four conductive balls 230 shown in FIG. 2. There are two apertures 240 and 250 (or openings) extending through the circuit board 200, and each of these apertures 240 and 250 is aligned with a gap between the conductive balls 230. The antenna structure 220 also includes two channels 260 and 270, each of which aligns respectively with the two apertures 240 and 250 that extend through the circuit board 200. The two channels 260 and 270 may have a first portion with a first uniform shape (e.g., cylindrical) in the z-dimension and closer to the circuit board 200, while further including a second portion with a second (e.g., frustoconical) shape in the z-dimension away from the circuit board 200.

As an example, the IC package 210 may include a signal launch in the form of a transmitter antenna 280 configured to communicate (e.g., transmit) a signal through a corresponding aperture (e.g., 240) in the circuit board 200 and through a corresponding channel (e.g., 260) in the antenna structure 220. The transmitted signal may pass through an area surrounded by some of the balls 230 in the x-y plane (some shown in FIG. 2, but others not shown in the x-dimension). As another example, the IC package 210 may include a signal launch in the form of a receiver antenna 290 configured to communicate (e.g., receive) a signal after the signal passes through a corresponding channel (e.g., 270) in the antenna structure 220, through an aperture (e.g., 250) in the circuit board 200, and through an area surrounded by balls 230 in the x-y plane.

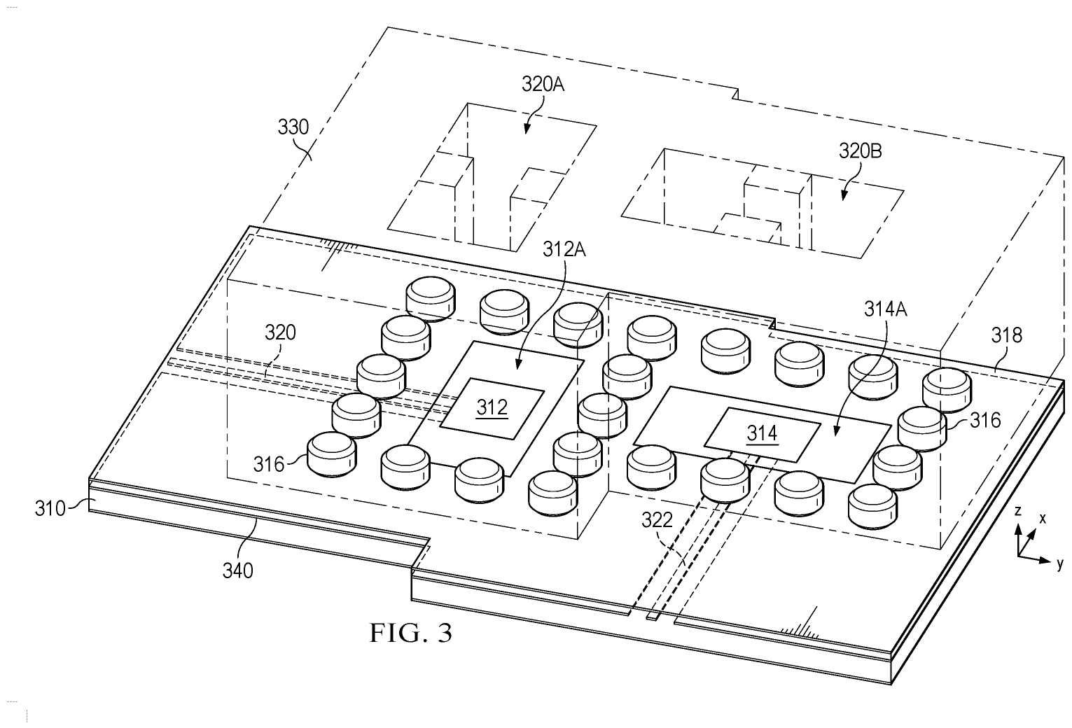

FIG. 3 is perspective diagram a package 310 into which are incorporated two signal launches, shown as patch antennas 312 and 314. Each of the patch antennas 312 and 314 is provided by a respective x-y plane conductive plate in a respective area 312A and 314A. Each of the areas 312A and 312B is surrounded by a respective set of four-by-five BGA balls 316. The respective conductive plates serving as the patch antennas 312 and 314 are co-planar (in the x-y plane) with a first metal plane 318. Accordingly, the areas 312A and 314A may be openings (e.g., square or rectangular) through the first metal plane 318. Further, each of the areas 312A and 314A may consume an area that otherwise would be populated with a two-by-three BGA pattern, that is, an area to accommodate six BGA balls. Beneath the first metal plane 318 (in the z-dimension) are signal communication feeds 320 and 322, each coupled to a respective one of the patch antennas 312 and 314, for example by conductive vias (not visible in the perspective shown). For example, the signal communication feed 320 can transmit a signal, through its respective z-dimension via (not shown), to the patch antenna 312 from where the signal may be communicated in the z-dimension, surrounded by an array of 4×5 BGA balls. As another example, a signal may be received by the patch antenna 314, isolated by a surrounding array of 4×5 BGA balls, with the signal coupled through a z-dimension conductive via (not shown) to the signal communication feed 322. The signal communication feeds 320 and 322 may be co-planar (in the x-y plane), and possibly formed during a same step, with a second metal plane 340. The second metal plane 340 is approximately parallel to the first metal plane 318, and the first and second metal planes 318 and 340 are separated from one another, for example by one more (e.g., dielectric) layers.

FIG. 3 also illustrates, in shadow form, an antenna structure 330 through which the above-described signals may pass. The antenna structure 330 includes a channel 320A that is positioned in the signal path of the first patch antenna 312. The antenna structure 330 also includes a channel 320B that is positioned in the signal path of the second patch antenna 314. In the illustrated example, each of the channels 320A and 320B has a generally H-shaped cross section in the x-y plane, forming a double ridge waveguide in the z-dimension. In both of FIGS. 2 and 3, a circuit board (not shown) is positioned between the package and the antenna structure, which may leave an air gap between the package and the antenna structure.

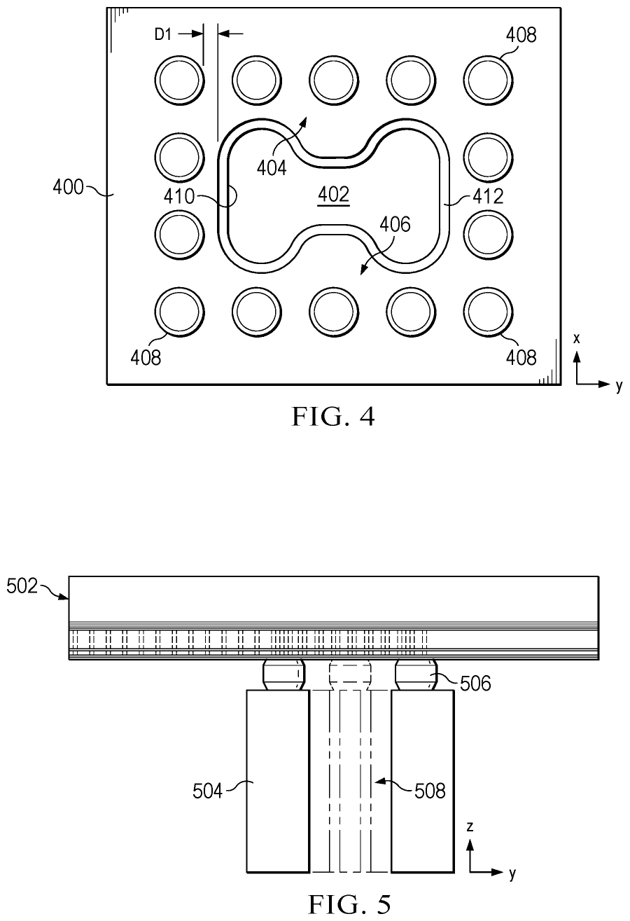

FIG. 4 is a diagram of a circuit board 400 including a double-ridge aperture 402. The aperture 402 has two ridges 404 and 406, which are formed from portions of the circuit board 400 extending inward toward a center of the aperture 402 and relative to an outermost rounded-corner rectangle perimeter of the aperture 402. Accordingly, the combination of the outermost rounded-corner rectangle and inward extending ridges 404 and 406 gives the aperture 402 a dog-bone shape or a dumbbell shape in the x-y plane. The aperture 402 also is surrounded by fourteen balls 408 in a five-by-four arrangement.

The aperture 402 has an outer boundary forming walls 410 in the z-dimension, and the walls 410 can be electro-plated, or otherwise coated, with copper or another conductive material 412. Each of the balls 408 can be attached to the circuit board 400 by solder, and it may be desirable to prevent the solder from touching the conductive material 412 on the walls 410 of the aperture 402. To prevent the solder from touching the conductive material 412, the assembly process may include applying solder mask to the circuit board 400, between the aperture 402 and the balls 408. After applying the solder mask to the circuit board 400, the assembly process may include attaching each ball 408 to a respective pad (not visible from the FIG. 4 perspective) on the circuit board 400 using solder. After the balls 408 are attached to circuit board 400, the solder mask may be removed.

It may be desirable for the area of the aperture 402 in the circuit board 400 to be small to maintain a sufficiently large distance between the balls 408 (or BGA pads) and the conductive material 412 of the aperture 402. This distance is represented in FIG. 4 as D1. A minimum design value for D1 (the solder mask distance) may impose a lower limit on the BGA perimeter surrounding each aperture 402. The difficulty and cost of milling and drilling a small aperture (especially an aperture with ridge features) may impose a lower limit on the size of each aperture 402.

Moreover, the cutoff frequency of a signal waveguide may be inversely proportional to the cross-sectional area of the waveguide. Thus, a reduction in the cross-sectional area of the aperture 402 may increase the cutoff frequency of the waveguide, which may act as a high-pass filter. If the cutoff frequency is larger than the frequency of the signals conducted by the waveguide, then the waveguide may impede the signals from passing through. It may be desirable to design the aperture to be large enough so that the cutoff frequency is much lower than the lowest RF frequency.

FIG. 5 is a cross-sectional side-view diagram of an IC package 502 coupled to a circuit board 504 (e.g., PCB) via balls 506. In some examples, the IC package 502 includes a signal launch (e.g., a slot antenna or patch antenna) on, or in relation to, the bottom surface of the IC package 502. A signal transmitted or received by the launch will pass through an area surrounded by the balls 506 (e.g., an air gap) and through an aperture 508 in the circuit board 504 and beneath the gap in the balls 506. Although not shown in FIG. 5, the signal also may pass through an antenna structure that is attached to a bottom surface of the circuit board 504. For the signals to travel between the launch and the antenna structure, the signals must pass, in the FIG. 5 z-dimension, through the gap surrounded by balls 506 and the aperture 508 in the circuit board 504.

As described in further detail below, reducing the distance between a launch and an antenna structure can improve the performance of a sensor device. For example, a direct physical coupling (or nearly direct coupling) between the launch and the antenna structure may improve any one or more of the cost, the complexity of fabrication and assembly, and the frequency characteristics of the device.

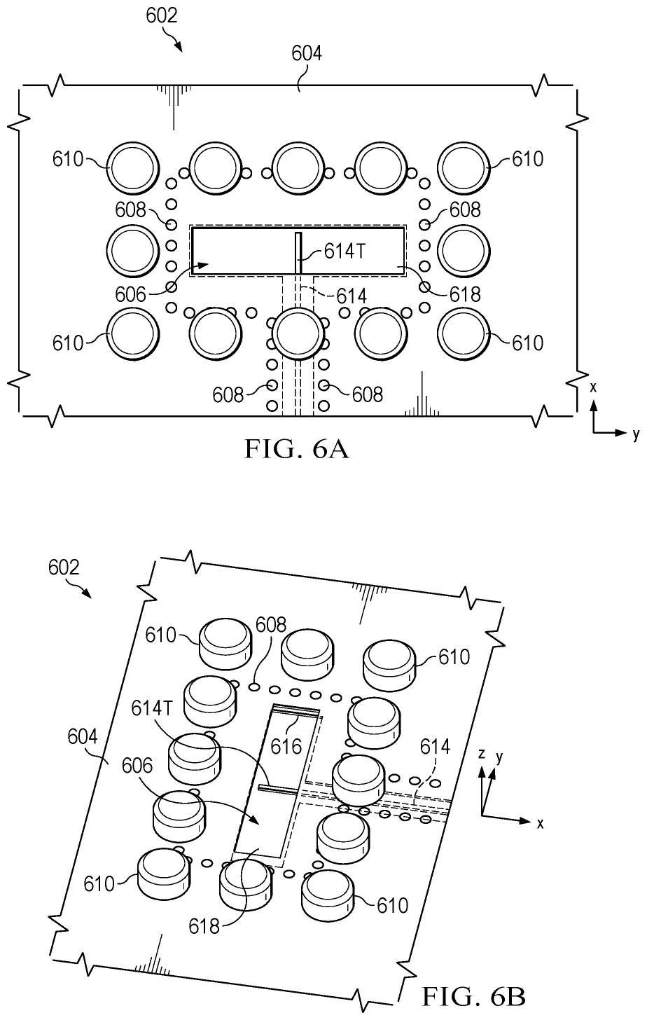

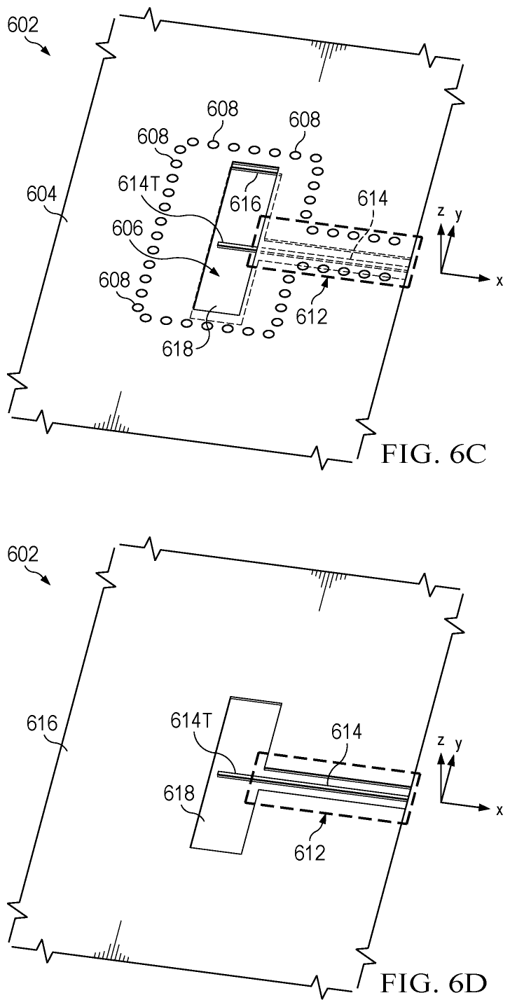

FIGS. 6A and 6B are respective plan and perspective diagrams of a signal launch in the form of a slot antenna 602, as may be integrated into an IC package. FIGS. 6C and 6D illustrate additional partial, perspective views of selected items of the FIGS. 6A and 6B slot antenna 602 to assist with illustrating various layering.

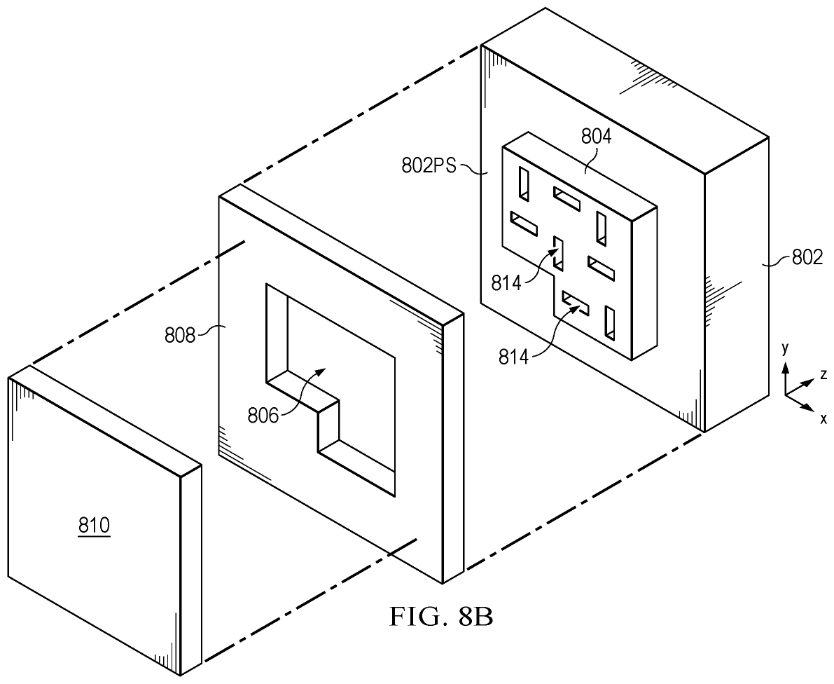

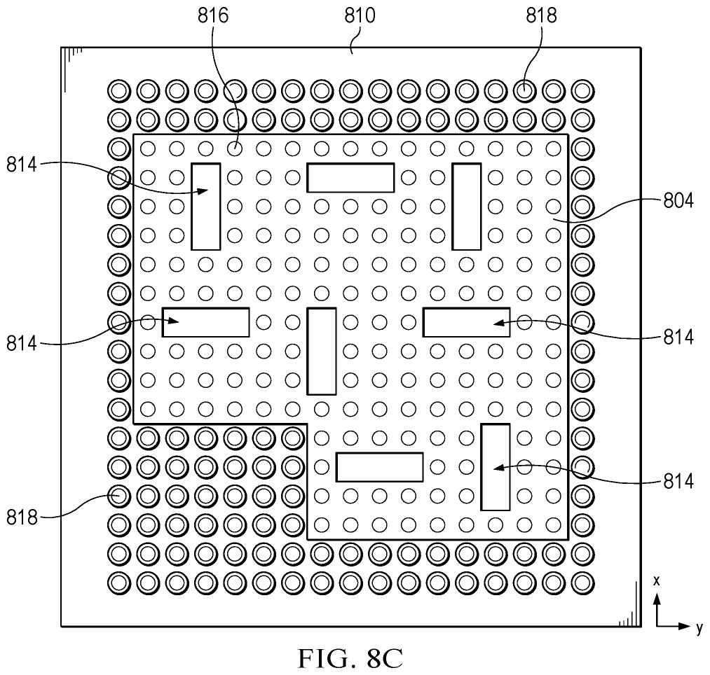

The FIG. 6A through 6C views include a first plane 604, for example from what may be considered a bottom view in terms of being located along a bottom of an IC package, where that IC package bottom faces a first surface of a circuit board, with an antenna structure located on a second surface of the circuit board, opposite the first surface, as shown later in FIG. 8A. The first plane 604 may be metal that is incorporated into an IC package, with only portions of the package shown for describing the slot antenna 602.

The slot antenna 602 includes a radiating aperture 606. The radiating aperture 606 is formed as a void, opening, or other passageway through the first plane 604 so that a wave signal may pass through it, in the z-dimension. The radiating aperture 606 may have, as examples, a rectangular or square perimeter shape. The radiating structure 606 may consume an area that otherwise would be populated with a one-by-three BGA pattern, that is, an area to accommodate three BGA balls. Accordingly, for a similar ball and pitch size as compared to FIG. 3, the antenna area in FIG. 6A is approximately fifty percent smaller. The radiating aperture 606 may be isolated with one or more structures. For example, a pattern of conductive vias 608 may be formed generally surrounding a majority of the radiating aperture 606 and extending in the z-dimension. As another example, a number of BGA balls 610 also may surround the radiating aperture 606. However, the BGA balls 610 extend upward in FIGS. 6A and 6B, while the vias 608 extend downward, so the layout of the BGA balls 610 atop the first plane 604 may fully surround the radiating aperture 606, while the vias 608 below the first plane 604 extend in part around the radiating aperture 606, but also form a pathway 612 away from the radiating aperture 606, as further described below.

The slot antenna 602 also includes a slot radiator 614. The slot radiator 614 is a conductor in a second planar location, which may be formed at a same time as a second plane 616 (FIG. 6D) different than, and possibly parallel to, the first plane 604 (FIGS. 6A-6C). The second plane 616 may be metal and may be below the first plane 604 in the z-dimension. The slot radiator 614 extends through (and receives signal protection by the vias 608 in) the pathway 612, both to and away from the area of the radiating aperture 606. The slot radiator 614 has a predetermined shape in the x-y plane as it extends along the pathway 612, for example rectangular, and that shape is uniform (continuous and unchanged) in a first direction until the slot radiator 614 terminates at a radiator tip 614T, and in the opposite direction as the slot radiator 614 extends in the x-y plane beyond the x-y boundaries of the radiating aperture 606. This is in contrast to other signal launches that may include a radiating element on one plane, a radiating patch with an area larger than the radiating element (when considered in the z-dimension within the boundary of the surrounding radiating aperture 606) on another plane, and a via between them. Away from the radiating aperture 606, the slot radiator 614 may be connected to additional structure (not shown), with the additional structure either providing a signal to be transmitted, or further receiving from the slot radiator 614 a signal that is received within the radiating aperture 606. The radiator tip 614T provides a terminal end located in the radiating aperture 606 in a first dimension (e.g., z-dimension), where the tip 614T is also within the outer boundaries of the radiating aperture 606 in a second and third dimension (x- and y-dimensions). Accordingly, the slot antenna 614, including a combination of the radiator tip 614T and the radiating aperture 606, can transmit or receive electromagnetic wave signals through the z-dimension and generally bounded by the x-y plane perimeter of the radiating aperture 606. Lastly, as part of, or related to, the slot antenna 602, a third plane 618 may be included in the configuration. The third plane 618 may serve as a back reflector to the cavity provided by the radiating aperture 606. In an example, the third plane 618 is a conductive surface and as a reflector is a distance from the first plane 604 (and the radiating aperture 606) of one-fourth the wavelength of the wave signal to be communicated by the slot antenna 602, in order to get appropriate performance from the system. Deviation from the correct distance will results in reduced bandwidth in performance and reduced gain. The vias 608 may extend to each of the first plane 604, the second plane 616, and the third plane 618. Accordingly, each of those planes can have a same potential (e.g., ground).

From the above, it may be appreciated that the slot antenna 602 may occupy the area of about three of the balls 610. The balls 610 can be arranged in a three-by-five perimeter surrounding the radiating aperture 606 because of its small size. While having a smaller size, the slot antenna 602 also may provide one or more of other various favorable attributes. The slot antenna 602 may have a larger bandwidth of return loss that is below a threshold level, as compared to a similarly sized patch antenna. As just an example, the slot antenna 602 may have a bandwidth of approximately 6.0 GHz of return loss with a return loss less than −20 dB, whereas a patch antenna may have a bandwidth of 2.5 GHz with a return loss less than −20 dB. The insertion loss for both types of antennas may be approximately −1 dB across the relevant bandwidth.

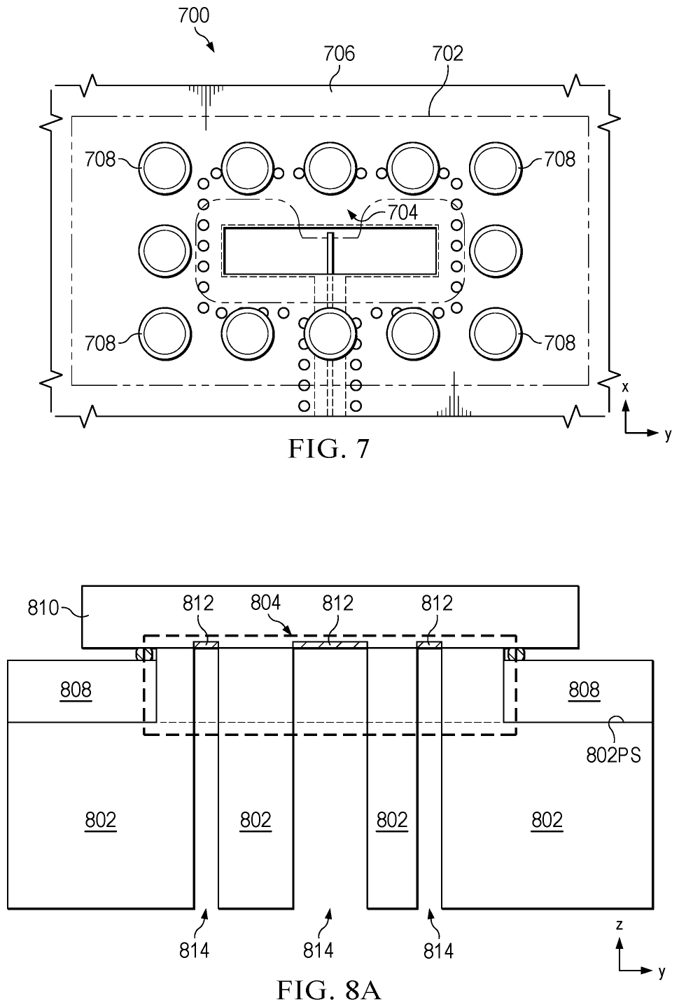

FIG. 7 is a diagram of a single-ridge aperture for a slot antenna 700. FIG. 7 shows a circuit board 702 including a ridge 704, and FIG. 7 also shows an IC package 706 including the slot antenna 700. The slot antenna 700 is small enough to fit within a three-by-five BGA perimeter. Given the relationship between size and cutoff frequency, the slot antenna 700 may have a relatively low cutoff frequency. The ridge 704 may reduce this cutoff frequency to a more acceptable level.

As shown in FIG. 7, an aperture in the circuit board 702 is surrounded by a perimeter of three-by-five BGA balls 708. Depending on the BGA pitch, the dimensions of this aperture may be less than two millimeters by one millimeter. Creating an aperture of this size in the circuit board 702 by, for example, milling, may be difficult and costly, especially if the fabrication includes metal deposition in the aperture. In contrast and as shown below, a no-ridge, single-ridge shape, or a double-ridge shape can be designed into the antenna structure, rather than milling that shape into the circuit board 702. Moreover, the metal deposition (e.g., electro-plating) can be performed on the antenna structure, rather than metal deposition on the circuit board.

FIG. 8A is a cross-sectional side-view, and FIG. 8B is a perspective and exploded view, of an antenna structure 802 that includes a bottom planar surface 802PS. The antenna structure 802 includes an extension 804 (FIG. 8B, and generally outlined in dashed fashion in FIG. 8A) protruding away (e.g., in the z-dimension) from the planar surface 802PS. FIG. 8B depicts the extension 804 as generally square-shaped or rectangular-shaped, but the extension 804 may have a different shape such as a circle, or an oval, and/or the extension 804 may have rounded corners. When the three exploded-view components of FIG. 8B are assembled as shown in FIG. 8A, the extension 804 may extend through an opening 806 in a circuit board 808. The opening 806 may be formed as an aperture or cutout, either by removing or avoiding the formation of material in the desired area. The circuit board 808 is between an IC package 810 and the antenna structure 802. For example, the IC package 810 may be larger than the opening 806 in the x- and y-dimensions, and it may be attached to a first surface of the circuit board 808, while the antenna structure 802 may be attached to a second surface of the circuit board 808, opposite the first surface. The IC package 810 includes one or more launches 812 (FIG. 8A) at or near its bottom surface. Each of the launches 812 may take various forms, for example including but not limited to the slot antenna 602 of earlier Figures. The extension 804 fits through the opening 806 and extends to contact, or position in close proximity (e.g., a range from 100 μm to 200 μm) to, the bottom of the package 810. The antenna structure 802 includes one or more waveguide channels 814, or passages/openings, through the material forming the antenna structure 802, in one-to-one correspondence, and aligning, with each of the one or more launches 812. Accordingly, in FIG. 8A, each waveguide channel 814 generally provides a z-dimension radio-frequency (RF) pathway or electromagnetic wave coupling mechanism for a signal radiating to, or from, a respective launch 812. Also, the cross-sectional shape of each waveguide channel 814, in the x-y plane, may be rectangular with zero, one, two, or more ridges. By directly coupling to the bottom surface of the IC package 810, the antenna structure 802 may eliminate any air gap between the IC package 810 and the antenna structure 802. Elimination of such an air gap may reduce the leakage that may occur as signals communicate between a launch 812 on the IC package 810 and the antenna structure 802.

FIG. 8C illustrates a plan view of portions of the interfacing area between the antenna structure extension 804 and the bottom surface of the IC package 810. From the FIG. 8C perspective, it may be seen that each waveguide channel 814 is surrounded by BGA contact pads 816, to which a BGA ball could be connected. However, those BGA balls are eliminated in a portion of the bottom surface of the IC package 810, so that the extension 804 can be positioned to contact, or approach, the bottom surface of the IC package 810. Elsewhere, outside the boundary of the antenna structure extension 804, a corresponding BGA ball 818 is positioned adjacent a BGA contact pad (not visible, as beneath the BGA ball in each instance). Also from FIGS. 8A and 8B, it should be understood with reference to FIG. 8C that each waveguide channel 814 aligns with a corresponding one of the package launches 812. Also in the illustrated example, the surrounding BGA contact pads 816 are in a four-by-three patterns surrounding each waveguide channel 814. Further, only a total of three BGA contact pads 816 are absent in a location of a waveguide channel 814.

If the bottom surface of the IC package 810 has eight launches 812, as just an example, the antenna structure 802 may include a single extension 804 with eight waveguide channels 814, or the antenna structure 802 may include a more than one extension 804, where each extension 804 has one or more waveguide channels 814. Also, if the antenna structure 802 has plural extensions 804, the circuit board 808 may include a single opening 806 through which the plural extensions fit, or alternatively the circuit board 808 may have plural openings, for example in one-to-one correspondence with each of the extensions from the antenna structure. It may be easier to fabricate the antenna structure 802 with a single extension 804 and to fabricate the circuit board 808 with a single opening 806, as compared to creating multiple extensions on the antenna structure 802 and creating multiple openings on the circuit board 808. In examples in which the antenna structure 802 has more than one waveguide channel 814, each waveguide channel 814 may be electrically isolated from the other waveguide channel(s). In some examples, the waveguide channels extend laterally outward from the single protrusion to route signals to/from antenna apertures and/or other interfaces.

Using opening 806 instead of a waveguide built into the circuit board 808 may reduce cost and complexity because the process of milling the waveguide into the circuit board 808 can be eliminated. It may be easier and less expensive to build a waveguide channel into the antenna structure 802, as compared to building the waveguide into the circuit board 808. In addition, the design shown in FIGS. 8A-8C may reduce the signal losses, especially if there is no air gap between the bottom surface of the package 810 and the antenna structure 802 (including its extension 804).

Moreover, t h e antenna structure 802 can be designed to prevent solder from creating a bridge from a BGA pad to a waveguide channel in the antenna structure 802. For example, t h e antenna structure 802 may include one or more waveguide channels that are coated or plated with metal. During the process of attaching the IC package 810 to other components shown, the solder will not be near these waveguide channels. In addition, the antenna structure 802 may be attached to the bottom surface of the circuit board 808 after the bottom surface of the IC package 810 is soldered to the top surface of the circuit board 808. Thus, there is reduced or little risk that solder will create a bridge between a BGA pad and a waveguide channel, as compared to electro-plating a waveguide through the circuit board 808. Additionally, there is reduced or little risk that solder mask will inadvertently enter a waveguide channel of the antenna structure 802.

The antenna structure 802 may include material such as nylon, aluminum, polymer, or plastic, which may include deposited metal such as copper. The deposited metal may be formed on the outline of each waveguide channel 814 using electro-plating or any other means for metal deposition. In examples in which the antenna structure 802 is metal, the antenna structure 802 may not include additional metal deposition and/or metal plating. Although FIGS. 8A-8B depict the waveguide channels as generally in the z-dimension, the channels may be routed through the antenna structure 802 in any direction. Each of the waveguide channels in the antenna structure 802 may have a single-ridge design (see, e.g., FIG. 7) or a double-ridge design (see, e.g., FIG. 4) to improve the frequency characteristics of the respective waveguide channel. The improved frequency characteristics may allow for the board opening 806 to be designed smaller without degrading performance.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

It is understood that the present disclosure provides a number of exemplary embodiments and that modifications are possible to these embodiments. Such modifications are expressly within the scope of this disclosure. Furthermore, application of these teachings to other environments, applications, and/or purposes is consistent with and contemplated by the present disclosure.

What is claimed is:

1. A device comprising:
a circuit board including a top surface and a bottom surface;
a package including a bottom surface affixed relative to the top surface of the circuit board; and
an antenna structure affixed relative to the bottom surface of the circuit board, and
wherein the antenna structure extends through an opening in the circuit board.

2. The device of claim 1, wherein the bottom surface of the package is coupled to the top surface of the circuit board and the antenna structure is coupled to the bottom surface of the circuit board.

3. The device of claim 1, wherein the package includes at least one signal launch and the antenna structure includes at least one waveguide channel positioned for signal communication with the at least one signal launch.

4. The device of claim 3, wherein the antenna structure physically contacts the package.

5. The device of claim 3, wherein the at least one waveguide channel is a metal-coated waveguide channel.

6. The device of claim 5, wherein the metal-coated waveguide channel has a rectangular cross section with a ridge.

7. The device of claim 5,
wherein the metal-coated waveguide channel is a first metal-coated waveguide channel, and
wherein the antenna structure includes a second metal-coated waveguide channel positioned for signal communication with an additional signal launch of the package.

8. The device of claim 7 wherein each of the at least one signal launch and the additional signal launch includes a slot antenna.

9. The device of claim 8, wherein the slot antenna comprises:
a first plane with an aperture; and
a radiating element aligned in a plane parallel to, and separate from, the first plane, the radiating element having a tip aligned in a position that is in a first dimension within boundaries of the aperture in a second and third dimension.

10. The device of claim 9, wherein the radiating element has a uniform shape at the position and in an area extending beyond the boundaries of the aperture in the second and third dimension.

11. The device of claim 3, wherein the at least one signal launch includes a slot antenna.

12. The device of claim 11, wherein the slot antenna comprises:
a first plane with an aperture; and
a radiating element aligned in a plane parallel to, and separate from, the first plane, the radiating element having a tip aligned in a position that is in a first dimension within boundaries of the aperture in a second and third dimension.

13. The device of claim 12, wherein the radiating element has a uniform shape at the position and in an area extending beyond the boundaries of the aperture in the second and third dimension.

14. The device of claim 1, further comprising a ball grid array (BGA) coupled to the top surface of the circuit board, wherein the bottom surface of the package is coupled to the top surface of the circuit board via the BGA.

15. The device of claim 1, wherein the opening in the circuit board is a first opening, and wherein the antenna structure includes:
a first extension protruding through the first opening in the circuit board; and a second extension protruding through a second opening in the circuit board to couple to the bottom surface of the package.

16. The device of claim 1, wherein the antenna structure includes:
an extension protruding through the opening in the circuit board,
at least two waveguide channels in the extension.

17. The device of claim 16,
wherein the package includes at least two signal launches, and
wherein each waveguide channel of the at least two waveguide channels is positioned for signal communication with a respective signal launch of the at least two signal launches.

18. A device comprising:
a circuit board including a surface and a cutout through the surface;
an antenna structure coupled to the surface of the circuit board, and
wherein the antenna structure includes an extension protruding through the cutout in the circuit board, and
wherein the antenna structure further includes a waveguide channel extending through the extension in the antenna structure.

19. The device of claim 18, further comprising a package including a bottom surface coupled to the circuit board,
wherein the bottom surface of the package is also coupled to the extension of the antenna structure.

20. The device of claim 19, wherein the package includes a slot antenna on the bottom surface of the package, wherein the slot antenna is coupled to the waveguide channel.
